(19) United States
(12) Patent Application Publication
(10) Pub. No.: US 2006/0120450 A1
(43) Pub. Date: Jun. 8, 2006

(54) Method and apparatus for multi-layered video encoding and decoding

(75) Inventors: Woo-jin Han, Suwon-si (KR); Sang-chang Cha, Hwaseong-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/290,515

(22) Filed: Dec. 1, 2005

Related U.S. Application Data
(60) Provisional application No. 60/632,545, filed on Dec. 3, 2004.

(30) Foreign Application Priority Data
Jan. 25, 2005 (KR) 10-2005-0006804

(51) Int. Cl. H04N 11/04; H04B 1/66; H04N 7/12; H04N 11/02

(52) U.S. Cl. 375/240.03; 375/240.24; 375/240.18

(57) ABSTRACT

A video compression method, and more particularly, a prediction method for efficiently eliminating redundancy within a video frame, and a video compression method and an apparatus using the prediction method are provided. There is provided a method for encoding video based on a multi-layer structure, including performing intra-prediction on a current intra-block using images of neighboring intra-blocks of the current intra-block to obtain a prediction residual, performing prediction on the current intra-block using an image of a lower layer region corresponding to the current intra-block to obtain a prediction residual, selecting one of the two prediction residuals that offers higher coding efficiency, and encoding the selected prediction residual.

### CROSS-REFERENCE TO RELATED APPLICATIONS

This application claims priority from Korean Patent Application No. 10-2005-0006804 filed on Jan. 25, 2005 in the Korean Intellectual Property Office, and U.S. Provisional Patent Application No. 60/632,545 filed on Dec. 3, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to a video compression method, and more particularly, to a prediction method for efficiently eliminating redundancy within a video frame, and a video compression method and an apparatus using the prediction method.

2. Description of the Related Art

With the development of information communication technology, including the Internet, video communication as well as text and voice communication, has increased dramatically. Conventional text communication cannot satisfy users' various demands, and thus, multimedia services that can provide various types of information such as text, pictures, and music have increased. However, multimedia data requires a storage media that have a large capacity and a wide bandwidth for transmission since the amount of multimedia data is usually large. Accordingly, a compression coding method is requisite for transmitting multimedia data including text, video and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy which takes into account human eyesight and its limited perception of high frequency variation.

Increasing attention is being directed towards H.264 or Advanced Video Coding (AVC) providing significantly improved compression efficiency over MPEG-4 coding. H.264, one of schemes designed to improve compression efficiency, uses directional intra-prediction to remove spatial similarity within a frame.

The directional intra-prediction involves predicting values of a current sub-block by copying pixels in a predetermined direction using pixels above and to the left of this sub-block and encoding only a difference between the current sub-block and the predicted value.

In H.264, a predicted block for a current block is generated based on a previously coded block and a difference between the current block and the predicted block is finally encoded. For luminance (luma) components, a predicted block is generated for each 4×4 or 16×16 macroblock. For each 4×4 luma block, there exist 9 prediction modes. For each 16×16 block, 4 prediction modes are available.

A video encoder compliant with H.264 selects a prediction mode of each block that minimizes a difference between a current block and a predicted block among the available prediction modes.

For the prediction of a 4×4 block, H. 264 uses 9 prediction modes including 8 directional prediction modes 0, 1, and 3 through 8 plus a DC prediction mode 2 using the average of 8 neighboring pixels as shown in FIG. 1.

FIG. 2 shows an example of labeling of prediction samples A through M for explaining the 9 prediction modes. In this case, previously decoded samples A through M are used to form a predicted block (region including a through p). If samples E, F, G, and H are not available, sample D will be copied to their locations to virtually form the samples E, F, G, and H.

The 9 prediction modes shown in FIG. 1 will now be described more fully with reference to FIG. 3.

For mode 0 (vertical) and mode 1 (horizontal), pixels of a predicted block are formed by extrapolation from upper samples A, B, C, and D, and from left samples I, J, K, and L, respectively. For mode 2 (DC), all pixels of a predicted block are predicted by a mean value of upper and left samples A, B, C, D, I, J, K, and L.

For mode 3 (diagonal down left), pixels of a predicted block are formed by interpolation at a 45-degree angle from the upper right to the lower left corner. For mode 4 (diagonal down right), pixels of a predicted block are formed by extrapolation at a 45-degree angle from the upper left to the lower right corner. For mode 5 (vertical right), pixels of a predicted block are formed by extrapolation at an approximately 26.6 degree angle (width/height=1/2) from the upper edge to the lower edge, slightly drifting to the right.

In mode 6 (horizontal down), pixels of a predicted block are formed by extrapolation at an approximately 26.6 degree angle from the left edge to the right edge, slightly drifting downwards. In mode 7 (vertical left), pixels of a predicted block are formed by extrapolation at an approximately 26.6 degree angle (width/height=1/2) from the upper edge to the lower edge, slightly drifting to the left. In mode 8 (horizontal up), pixels of a predicted block are formed by extrapolation at an approximately 26.6 degree angle (width/height=2/1) from the left edge to the right edge, slightly drifting upwards.

In each mode, arrows indicate the direction in which prediction pixels are derived. Samples of a predicted block can be formed from a weighted average of the reference samples A through M. For example, sample d may be predicted by the following Equation (1):
d=round(B/4+C/2+D/4) (1)
where round ( ) is a function that rounds a value to an integer value.

There are four prediction modes 0, 1, 2, and 3 for prediction of 16×16 luma components of a macroblock. In mode 0 and mode 1, pixels of a predicted block are formed by extrapolation from upper samples H and from left samples V, respectively. In mode 2, pixels of a predicted block are computed by a mean value of the upper and left samples H and V. Lastly, in mode 3, pixels of a predicted block are formed using a linear “plane” function fitted to the upper and left samples H and V. The mode 3 is more suitable for areas of smoothly-varying luminance.

Along with efforts to improving the efficiency of video coding, research is being actively conducted into a video coding method supporting scalability that is the ability to adjust the resolution, frame rate, and signal-to-noise ratio (SNR) of transmitted video data according to various network environments.

Moving Picture Experts Group (MPEG)-21 PART-13 standardization for scalable video coding is under way. In particular, a multi-layered video coding method is widely recognized as a promising technique. For example, a bitstream may consist of multiple layers, i.e., a base layer (quarter common intermediate format (QCIF)), enhanced layer 1 (common intermediate format (CIF)), and enhanced layer 2 (2CIF) with different resolutions or frame rates.

Because the existing directional intra-prediction is not based on a multi-layered structure, directional search in the intra-prediction as well as coding are performed independently for each layer. Thus, in order to compatibly employ the H.264-based directional intra-prediction under multi-layer environments, there still exists a need for improvements.

It is inefficient to use intra-prediction independently for each layer because a similarity between intra-prediction modes in each layer cannot be utilized. For example, when a vertical intra-prediction mode is used in a base layer, it is highly possible that intra-prediction in the vertical direction or neighboring direction will be used in a current layer. However, because a framework having a multi-layer structure while using the H.264-based directional intra-prediction was recently proposed, there is an urgent need to develop an efficient encoding technique using a similarity between intra-prediction modes in each layer.

Multi-layered video coding enables the use of prediction using texture information from a lower layer at the same temporal positions as a current frame, hereinafter called ‘a base layer (BL) prediction’ mode, as well as the intra-prediction mode. A BL prediction mode mostly exhibits moderate prediction performance while an intra-prediction mode shows good or bad performance inconstantly. Thus, the conventional H.264 standard proposes an approach including selecting a better prediction mode between an intra-prediction mode and a BL prediction mode for each macroblock and encoding the macroblock using the selected prediction mode.

It is assumed that an image exists within a frame and the image is segmented into a shadowed region for which a BL prediction mode is more suitable and a non-shadowed region for which an intra-prediction mode is more suitable. In FIG. 4, a dotted line and a solid line respectively indicate a boundary between 4×4 blocks and a boundary between macroblocks.

When the approach proposed by the conventional H.264 is applied, an image is segmented into macroblocks 10a selected to be encoded using a BL prediction mode and macroblocks 10a selected to be encoded using an intra-prediction mode as shown in FIG. 5. However, this approach is not suitable for an image with detailed edges within a macroblock as shown in FIG. 4 because the macroblock contains both a region for which an intra-prediction mode is more suitable and a region for which a BL prediction mode is more suitable. Thus, selecting one of the two modes for each macroblock cannot ensure good coding performance.

### SUMMARY OF THE INVENTION

The present invention provides a method for selecting a better prediction mode of an intra-prediction mode and a BL prediction mode for a region smaller than a macroblock.

The present invention also provides a modified intra-prediction mode combining the BL prediction mode into a conventional intra-prediction mode.

The present invention also provides a method for selecting a better prediction mode of a mode of calculating a temporal residual and a BL prediction mode for each motion block by using the same selection scheme as above for temporal prediction as well.

The above stated aspects as well as other aspects, features and advantages, of the present invention will become clear to those skilled in the art upon review of the following description.

According to an aspect of the present invention, there is provided a method for encoding video based on a multi-layer structure, including: performing intra-prediction on a current intra-block using images of neighboring intra-blocks of the current intra-block to obtain a prediction residual; performing prediction on the current intra-block using an image of a lower layer region corresponding to the current intra-block to obtain a prediction residual; selecting one of the two prediction residuals that offers higher coding efficiency; and encoding the selected prediction residual.

According to an aspect of the present invention, there is provided a method for decoding video based on a multi-layer structure, including: extracting modified intra-prediction mode and texture data for each intra-block; generating a residual image for the intra-block from the texture data; generating a predicted block for a current intra-block using previously reconstructed neighboring intra-blocks or previously reconstructed lower layer image according to the modified intra-prediction mode; and adding the predicted block to the residual image and reconstructing an image of the current intra-block.

According to another aspect of the present invention, there is provided a method for encoding video based on a multi-layer structure, including: performing temporal prediction on a current motion block using an image of a region of a reference frame corresponding to the current motion block to obtain a prediction residual; performing prediction on the current motion block using an image of a lower layer region corresponding to the current motion block to obtain a prediction residual; selecting one of the two prediction residuals that offers higher coding efficiency; and encoding the selected prediction residual.

According to still another aspect of the present invention, there is provided a method for decoding video based on a multi-layer structure, including: extracting selected mode, motion data, and texture data for each motion block; generating a residual image for the motion block from the texture data; selecting an image of a region of a previously reconstructed reference frame corresponding to the motion block or a previously reconstructed lower layer image according to the selected mode; and adding the selected image to the residual image and reconstructing an image of the motion block.

According to a further aspect of the present invention, there is provided a multi-layered video encoder including: a unit configured to perform intra-prediction on a current intra-block using images of neighboring intra-blocks to the current intra-block to obtain a prediction residual; a unit configured to perform prediction on the current intra-block using an image of a lower layer region corresponding to the current intra-block to obtain a prediction residual, a unit configured to select one of the two prediction residuals that offers higher coding efficiency, and a unit configured to encode the selected prediction residual.

According to yet another aspect of the present invention, there is provided a multi-layered video decoder including: a unit configured to extract modified intra-prediction mode and texture data for each intra-block; a unit configured to generate a residual image for the intra-block from the texture data; a unit configured to generate a predicted block for a current intra-block using previously reconstructed neighboring intra-blocks or previously reconstructed lower layer image according to the modified intra-prediction mode; and a unit configured to add the predicted block to the residual image and reconstructing an image of the current intra-block.

### BRIEF DESCRIPTION OF THE DRAWINGS

The above and other features and advantages of the present invention will become more apparent by describing in detail illustrative, non-limiting exemplary embodiments thereof with reference to the attached drawings in which:

FIG. 1 shows conventional H.264 intra-prediction modes;

FIG. 2 shows an example of labeling of prediction samples for explaining the intra-prediction modes shown in FIG. 1;

FIG. 3 is a detailed diagram of the intra-prediction modes shown in FIG. 1;

FIG. 4 shows an example of an input image;

FIG. 5 shows the result of selecting one of two modes for each macroblock according to a conventional art;

FIG. 6 shows the result of selecting one of two modes for each macroblock according to an exemplary embodiment of the present invention;

FIG. 7 is a schematic diagram of a modified intra-prediction mode according to an exemplary embodiment the present invention;

FIG. 8 is a block diagram of a video encoder according to an exemplary embodiment of the present invention;

FIG. 9 shows a region being used as a reference in a modified intra-prediction mode;

FIG. 10 shows an example for creating a macroblock by selecting an optimum prediction mode for each intra-block;

FIG. 11 is a block diagram of a video decoder according to an exemplary embodiment of the present invention;

FIG. 12 shows an example of hierarchical variable size block matching (HVSBM);

FIG. 13 shows a macroblock constructed by selecting a mode for each motion block;

FIG. 14 is a block diagram of a video encoder according to an exemplary embodiment of the present invention; and

FIG. 15 is a block diagram of a video decoder according to an exemplary embodiment of the present invention.

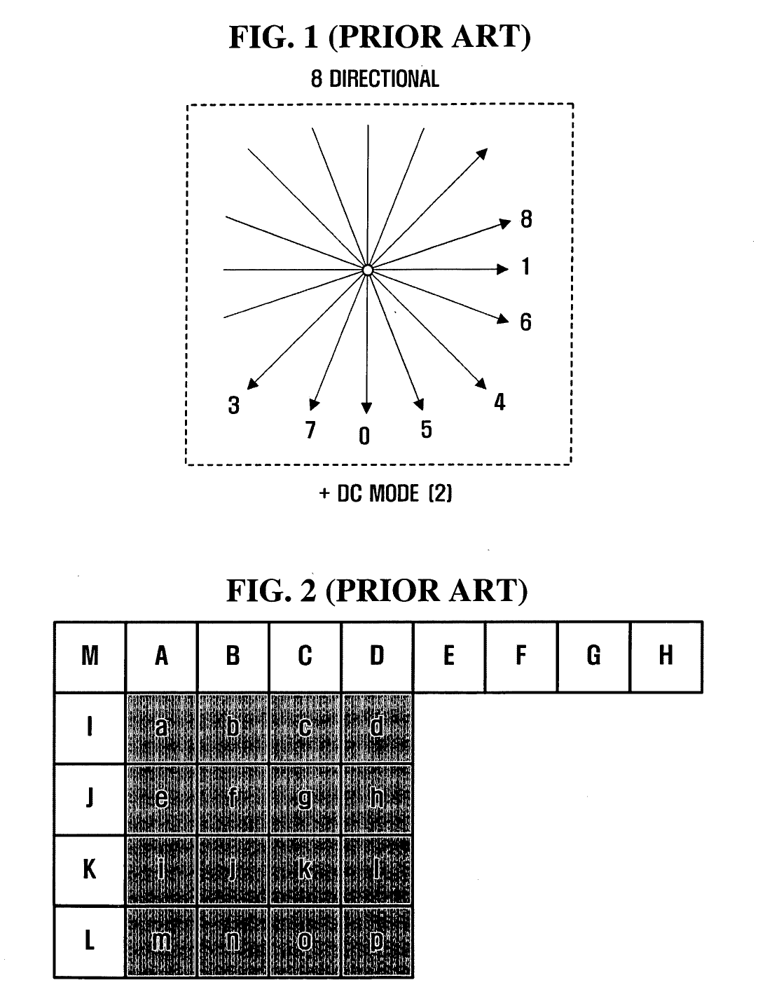

### DETAILED DESCRIPTION OF THE EXEMPLARY EMBODIMENTS

The present invention will now be described more fully with reference to the accompanying drawings, in which exemplary embodiments of this invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which preferred embodiments of the invention are shown.

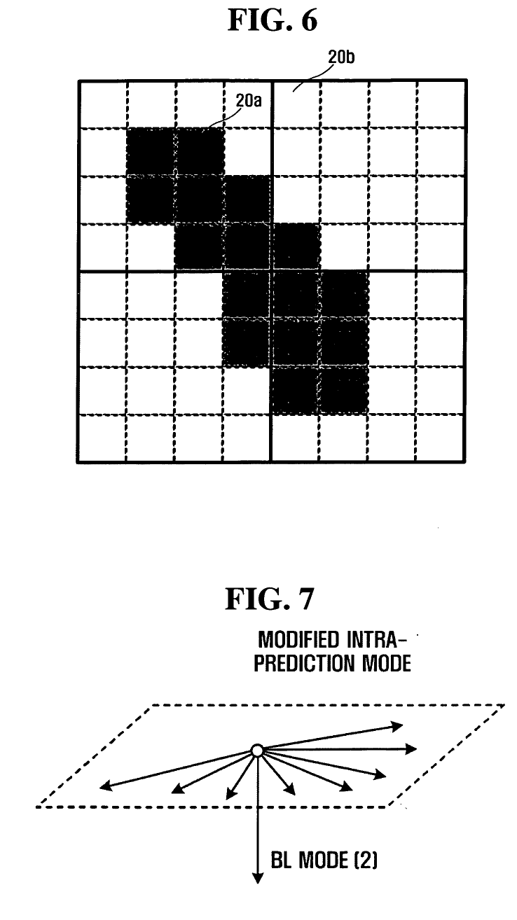

FIG. 6 shows the result of selecting a better prediction mode between an intra-prediction mode and a BL prediction mode for each intra-block (e.g., a 4×4 block) according to an exemplary embodiment of the present invention. Referring to FIG. 6, unlike the approach proposed by the conventional H.264 shown in FIG. 5, an exemplary embodiment of the present invention can accomplish mode selection for a smaller region than a macroblock. The region for this selection may have a size suitable for performing an intra-prediction mode.

In a conventional intra-prediction mode, a luminance component utilizes 4×4 and 16×16 block-size modes while a chrominance component utilizes an 8×8 block-size mode. An exemplary embodiment of the present invention can apply to 4×4 and 8×8 modes except a 16×16 mode which a 16×16 block has the same size as a macroblock. Hereinafter, an exemplary embodiment of the present invention will be described assuming that a 4×4 mode is used for intra-prediction.

Assuming that one of an intra-prediction mode and a BL prediction mode is selected for each 4×4 block, the BL prediction mode can be added as one of submodes of a conventional intra-prediction mode. In this way, and intra-prediction mode combining a BL prediction mode into the conventional intra-prediction mode is hereinafter referred to as a “modified intra-prediction mode” according to an exemplary embodiment of the present invention.

Table 1 shows submodes of the modified intra-prediction mode.

TABLE 1

| Mode No. | Name |
|---|---|
| 0 | Vertical (prediction mode) |
| 1 | Horizontal (prediction mode) |
| 2 | Base Layer (prediction mode) |
| 3 | Diagonal_Down_Left (prediction mode) |
| 4 | Diagonal_Down_Right (prediction mode) |
| 5 | Vertical_Right (prediction mode) |
| 6 | Horizontal_Down (prediction mode) |
| 7 | Vertical_Left (prediction mode) |
| 8 | Horizontal_Up (prediction mode) |

As shown in Table 1, the modified intra-prediction mode contains a BL prediction mode instead of a DC mode that is mode 2 in a conventional intra-prediction mode because an intra-block that can be represented in the DC mode that is non-directional can be predicted sufficiently well using the BL prediction mode. Furthermore, the modified prediction mode including the BL prediction mode can prevent overhead due to addition of a new mode.

The modified intra-prediction mode is schematically illustrated in FIG. 7. The modified intra-prediction mode consists of 8 directional modes and one BL prediction mode. In this case, since the BL prediction mode can be considered to have a downward direction (toward a base layer), the modified intra-prediction mode includes a total of 9 directional modes.

Alternatively, when a DC mode cannot be predicted by a BL prediction mode, the BL prediction mode can be added to the conventional intra-prediction mode as mode ‘9’ as shown in the following Table 2. Exemplary embodiments of the present invention described hereinafter assume that the modified intra-prediction mode consists of submodes as shown in Table 1.

TABLE 2

| Mode No. | Name |
|---|---|
| 0 | Vertical (prediction mode) |
| 1 | Horizontal (prediction mode) |
| 2 | DC (prediction mode) |
| 3 | Diagonal_Down_Left (prediction mode) |
| 4 | Diagonal_Down_Right (prediction mode) |
| 5 | Vertical_Right (prediction mode) |
| 6 | Horizontal_Down (prediction mode) |
| 7 | Vertical_Left (prediction mode) |
| 8 | Horizontal_Up (prediction mode) |
| 9 | Base Layer (prediction mode) |

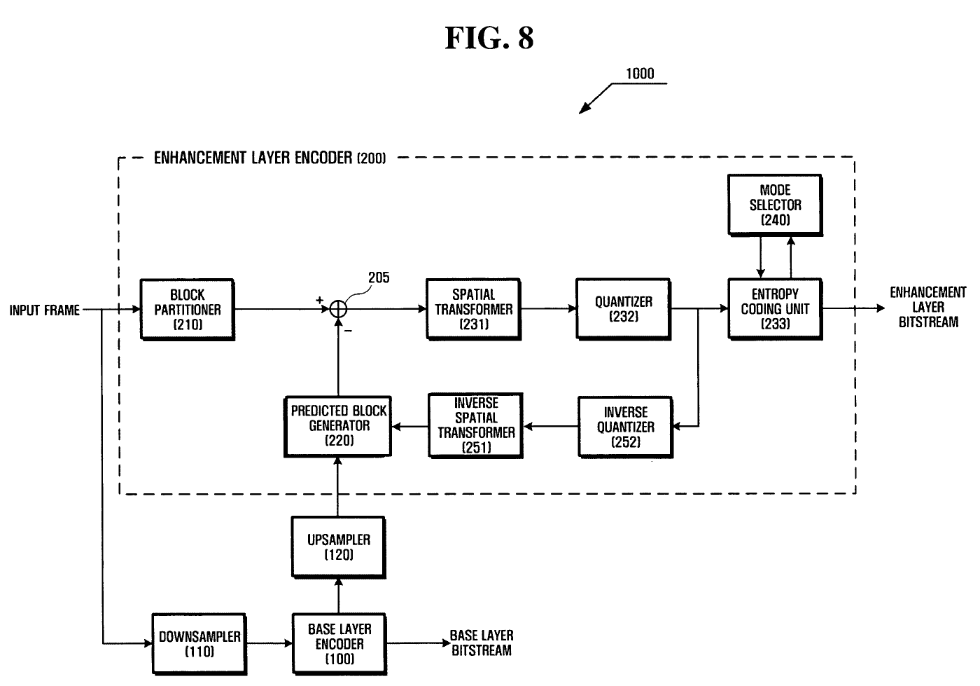

FIG. 8 is a block diagram of a video encoder 1000 according to a first exemplary embodiment of the present invention. Referring to FIG. 8, the video encoder 1000 mainly includes a base layer encoder 100 and an enhancement layer encoder 200. The configuration of the enhancement layer encoder 200 will now be described.

A block partitioner 210 segments an input frame into multiple intra-blocks. While each intra-block may have a size less than a macroblock, exemplary embodiments of the present invention will be described assuming that each intra-block has a size of 4×4 pixels. Those multiple intra-blocks are the fed into a subtractor 205.

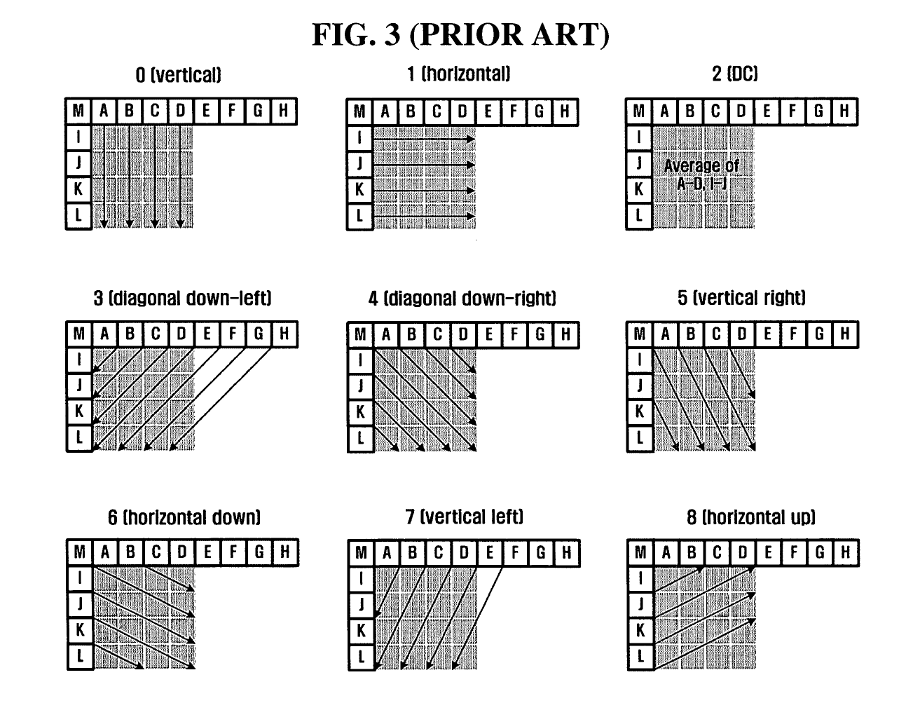

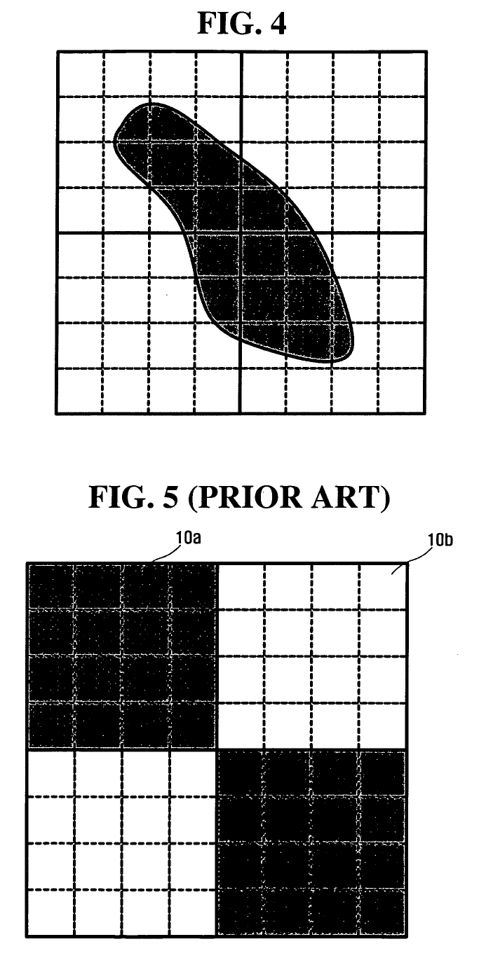

A predicted block generator 220 generates a predicted block associated with a current block for each submode of the modified intra-prediction mode using a reconstructed enhancement layer block received from an inverse spatial transformer 251 and a reconstructed base layer image provided by the base layer encoder 100. When a predicted block is generated using a reconstructed enhancement layer block, a calculation process as shown in FIG. 3 is used. In this case, since a DC mode is replaced by a BL prediction mode, the DC mode is excluded from the submodes of the intra-prediction mode. When a predicted block is generated using a reconstructed base layer image, the reconstructed base layer image may be used directly as the predicted block or be upsampled to the resolution of an enhancement layer before being used as the predicted block.

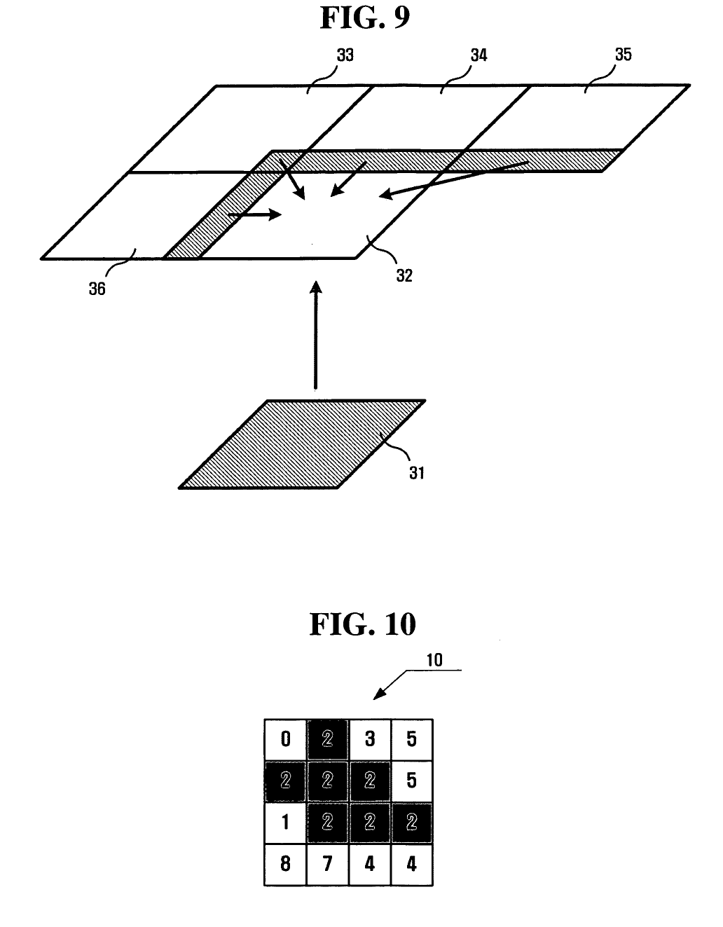

Referring to FIG. 9 showing a region being used as a reference in a modified intra-prediction mode, the predicted block generator 220 generates a predicted block 32 of a current intra-block for each of the prediction modes 0, 1, and 3 through 8 using its previously reconstructed neighboring enhancement layer blocks 33, 34, 35, and 36, in particular, information about pixels of blocks adjacent to the current intra-block. For a prediction mode 2, a previously reconstructed base layer image 31 is used directly as a predicted block (when a base layer has the same resolution as an enhancement layer) or upsampled to the resolution of the enhancement layer (when the base layer has a different resolution than the enhancement layer) before being used as the predicted block. Of course, it will be readily apparent to those skilled in the art that a deblocking process may be performed before the reconstructed base layer image is used as a predicted block to reduce a block artifact.

The subtractor 205 subtracts a predicted block produced by the predicted block generator 220 from a current intra-block received from the block partitioner 210, thereby removing redundancy in the current intra-block.

Then, the difference between the predicted block and the current intra-block is lossily encoded as it passes through a spatial transformer 231 and a quantizer 232 and then losslessly encoded by an entropy coding unit 233.

The spatial transformer 231 performs spatial transform on a frame in which temporal redundancy has been removed by the subtractor 205 to create transform coefficients. Discrete Cosine Transform (DCT) or wavelet transform technique may be used for the spatial transform. A DCT coefficient is created when DCT is used for the spatial transform while a wavelet coefficient is produced when wavelet transform is used.

The quantizer 232 performs quantization on the transform coefficients obtained by the spatial transformer 231 to create quantization coefficients. Here, quantization is a methodology to express a transform coefficient expressed in an arbitrary real number as a finite number of bits. Known quantization techniques include scalar quantization, vector quantization, and the like. The simple scalar quantization technique is performed by dividing a transform coefficient by a value of a quantization table mapped to the coefficient and rounding the result to an integer value.

Embedded quantization is mainly used when wavelet transform is used for spatial transform. The embedded quantization exploits spatial redundancy and involves reducing a threshold value by one half and encoding a transform coefficient larger than the threshold value. Examples of embedded quantization techniques include Embedded Zerotrees Wavelet (EZW), Set Partitioning in Hierarchical Trees (SPIHT), and Embedded ZeroBlock Coding (EZBC).

The entropy coding unit 233 losslessly encodes the quantization coefficients generated by the quantizer 232 and a prediction mode selected by a mode selector 240 into an enhancement layer bitstream. Various coding schemes such as Huffman Coding, Arithmetic Coding, and Variable Length Coding may be employed for lossless coding.

The mode selector 240 compares the results obtained by the entropy coding unit for each of the submodes of the modified intra-prediction mode and selects a prediction mode that offers highest coding efficiency. Here, the coding efficiency is measured by the quality of an image at a given bit-rate. A cost function based on rate-distortion (RD) optimization is mainly used for evaluating the image quality. Because a lower cost means higher coding efficiency, the mode selector 240 selects a prediction mode that offers a minimum cost among the submodes of the modified intra-prediction mode.

A cost C in the cost function is calculated by equation (2):
C=E+λB (2)
where E and B respectively denote a difference between an original signal and a signal reconstructed by decoding encoded bits and the number of bits required to perform each prediction mode and λ is a Lagrangian coefficient used to control the ratio of E to B.

While the number of bits B may be defined as the number of bits required for texture data, it is more accurate to define it as the number of bits required for both each prediction mode and its corresponding texture data. This is because the result of entropy encoding may not be same as the mode number allocated to each prediction mode. In particular, since the conventional H.264 also encodes only the result saved through estimation from prediction modes of neighboring intra-blocks instead of the prediction mode, the encoded result may vary according to the efficiency of estimation.

The mode selector 240 selects a prediction mode for each intra-block. In other words, the mode selector determines an optimum prediction mode for each intra-block in a macroblock 10 as shown in FIG. 10. Here, shadowed blocks are encoded using a BL prediction mode while non-shadowed blocks are encoded using conventional directional intra-prediction modes.

An integer multiple of the number of intra-blocks, where the modified intra-prediction mode is used, may be same as the size of a macroblock size. However, the modified intra-prediction mode can be performed for a region obtained by arbitrarily partitioning a frame.

The entropy coding unit 233 that receives a prediction mode selected by the mode selector 240 through the comparison and selection outputs a bitstream corresponding to the selected prediction mode.

To support closed-loop encoding in order to reduce a drifting error caused due to a mismatch between an encoder and a decoder, the video encoder 1000 includes an inverse quantizer 252 and an inverse spatial transformer 251.

The inverse quantizer 252 performs inverse quantization on the coefficient quantized by the quantizer 232. The inverse quantization is an inverse operation of the quantization which has been performed by the quantizer 232.

The inverse spatial transformer 251 performs inverse spatial transform on the inversely quantized result to reconstruct a current intra-block that is then sent to the predicted block generator 220.

A downsampler 110 downsamples an input frame to the resolution of the base layer. The downsampler may be an MPEG downsampler, a wavelet downsampler, or others.

The base layer encoder 100 encodes the downsampled base layer frame into a base layer bitstream while decoding the encoded result. Texture information of a region of a base layer frame reconstructed through the decoding, which corresponds to a current intra-block in an enhancement layer, is transmitted to the predicted block generator 220. Of course, when the base layer has a different resolution than the enhancement layer, an upsamping process should be performed on the texture information by an upsampler 120 before it is transmitted to the predicted block generator 220. The upsampling process may be performed using the same or different technique than the downsampling process.

While the base layer encoder 100 may operate in the same manner as the enhancement layer encoder 200, it may also encode and/or decode a base layer frame using conventional intra-prediction, temporal prediction, and other prediction processes.

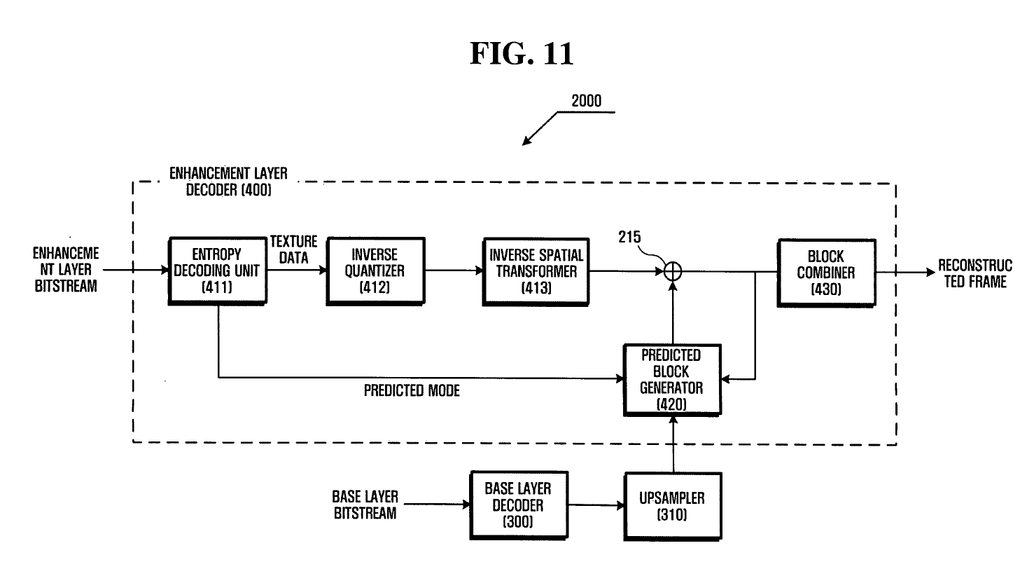

FIG. 11 is a block diagram of a video decoder 2000 according to a first exemplary embodiment of the present invention. The video decoder 2000 mainly includes a base layer decoder 300 and an enhancement layer decoder 400. The configuration of the enhancement layer decoder 400 will now be described.

An entropy decoding unit 411 performs lossless decoding that is an inverse operation of entropy encoding to extract a modified intra-prediction mode and texture data for each intra-block, which are then fed to a predicted block generator 420 and an inverse quantizer 412, respectively.

The inverse quantizer 412 performs inverse quantization on the texture data received from the entropy decoding unit 411. The inverse quantization is an inverse operation of the quantization which has been performed by the quantizer (232 of FIG. 8) of the video encoder (1000 of FIG. 8). For example, inverse scalar quantization can be performed by multiplying the texture data by its mapped value of the quantization table (the same as that used in the video encoder 1000).

An inverse spatial transformer 413 performs inverse spatial transform to reconstruct residual blocks from coefficients obtained after the inverse quantization. For example, when wavelet transform is used for spatial transform at the video encoder 1000, the inverse spatial transformer 413 performs inverse wavelet transform. When DCT is used for spatial transform, the inverse spatial transformer 413 performs inverse DCT.

The predicted block generator 420 generates a predicted block according to the prediction mode provided by the entropy decoding unit 411 using previously reconstructed neighboring intra-blocks of a current intra-block output from an adder 215 and a base layer image corresponding to the current intra-block reconstructed by the base layer decoder 300. For example, for modes 0, 1, and 3 through 8, a predicted block is generated using neighboring intra-blocks. For mode 2, the predicted block is generated using a base layer image.

The adder 215 adds the predicted block to a residual block reconstructed by the inverse spatial transformer 413, thereby reconstructing an image of the current intra-block. The output of the adder 215 is fed to the predicted block generator 420 and a block combiner 430 that then combines the reconstructed residual blocks to reconstruct a frame.

Meanwhile, the base layer decoder 300 reconstructs a base layer frame from a base layer bitstream. Texture information of a region of a base layer frame reconstructed through the decoding, which corresponds to a current intra-block in an enhancement layer, is provided to the predicted block generator 420. Of course, when a base layer has a different resolution than an enhancement layer, an upsampling process must be performed on the texture information by an upsampler 310 before it is transmitted to the predicted block generator 420.

While the base layer decoder 300 may operate in the same manner as the enhancement layer decoder 400, it may also encode and/or decode a base layer frame using conventional intra-prediction, temporal prediction, and other prediction processes.

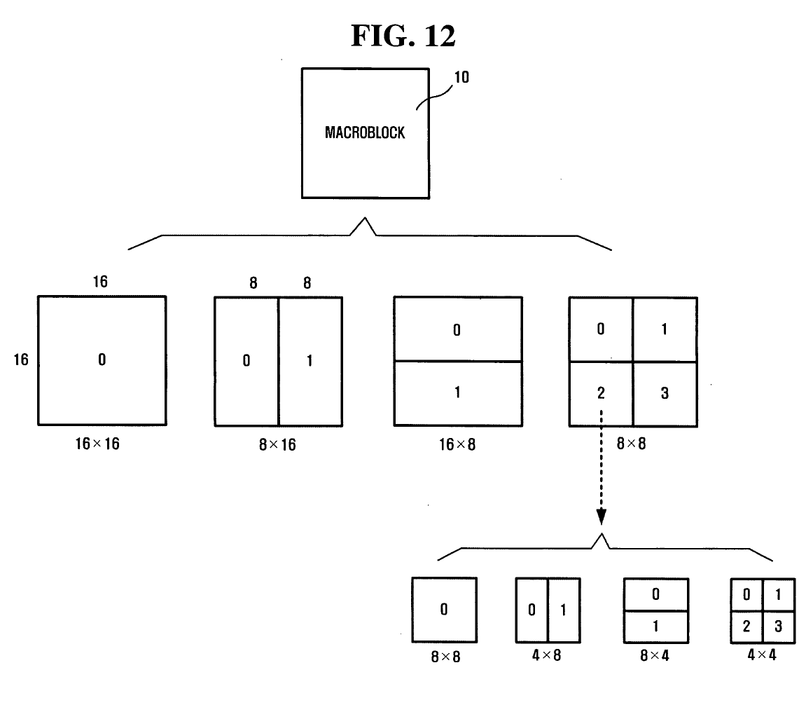

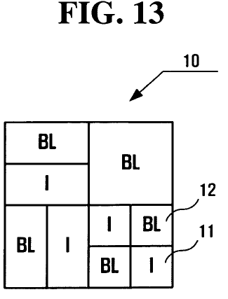

The present invention has been described above with reference to the first embodiment in which a BL prediction mode is added as one of submodes of an intra-prediction mode. In another exemplary embodiment (second embodiment), a BL prediction mode may be included in a temporal prediction process, which will be described below. Referring to FIG. 12, the conventional H.264 uses hierarchical variable size block matching (HVSBM) to remove temporal redundancy in each macroblock.

A macroblock 10 is partitioned into subblocks with four modes: 16×16, 8×16, 16×8, and 8×8 modes. Each 8×8 subblock can be further split into 4×8, 8×4, or 4×4 mode (if not split, a 8×8 mode is used). Thus, a maximum of 7 combinations of subblocks are allowed for each macroblock 10.

A combination of subblocks constituting the macroblock 10 that offers a minimum cost is selected as an optimum combination. When the macroblock 10 is split into smaller regions, accuracy in block matching increases and the amount of motion data (motion vectors, subblock modes, etc) increase together. Thus, the optimum combination of subblocks is selected to achieve optimum trade-off between the block matching accuracy and the amount of motion data. For example, a simple background image containing no complicated change may use a large size subblock mode while an image with complicated and detailed edges may use a small size subblock mode.

The feature of the second exemplary embodiment of the present invention lies in determining whether to apply a mode of calculating a temporal residual or a BL prediction mode for each subblock in a macroblock 10 composed of the optimum combination of subblocks In FIG. 13, I 11 and BL 12 respectively denote a subblock to be encoded using a temporal residual and a subblock to be encoded using a BL prediction mode.

A RD cost function shown in Equation (3) is used to select an optimal mode for each subblock. When Ci and Cb respectively denote costs required when temporal residual is used and when a BL prediction mode is used, Ei and Bi respectively denote a difference between an original signal and a reconstructed signal when the temporal residual is used and the number of bits required to encode motion data generated by temporal prediction and texture information obtained by the temporal residual, and Eb and Bb respectively denote a difference between an original signal and a reconstructed signal when the BL prediction mode is used and the number of bits required to encode information indicating the BL prediction mode and texture information obtained using the BL prediction mode, the costs Ci and Cb are defined by equation (3):
Cᵢ=Eᵢ+λBᵢ
C_{b}=E_{b}+λB_{b} (3)
By selecting a method that offers a smaller one of Cᵢ and C_{b} for each subblock, a macroblock constructed as shown in FIG. 13 can be obtained.

While the H.264 standard uses HVSBM to perform temporal prediction (including motion estimation and motion compensation), other standards such as MPEG may use fixed-size block matching. The second exemplary embodiment focuses on selecting a BL prediction mode or a mode of calculating a residual between a current block and a corresponding block in a reference frame for each block, regardless of whether a macroblock is partitioned into variable-size or fixed-size blocks. A variable-size block or fixed-size block that is a basic unit of calculating a motion vector is hereinafter referred to as a “motion block”.

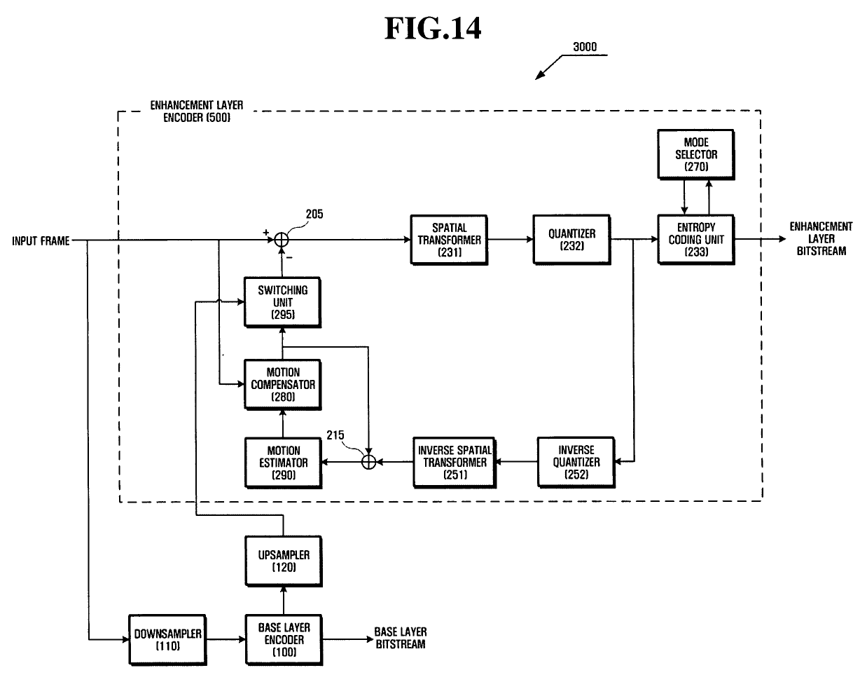

FIG. 14 is a block diagram of a video encoder 3000 according to a second exemplary embodiment of the present invention. Referring to FIG. 14, the video encoder 3000 mainly includes a base layer encoder 100 and an enhancement layer encoder 500. The configuration of the enhancement layer encoder 500 will now be described.

A motion estimator 290 performs motion estimation on a current frame using a reference frame to obtain motion vectors. The motion estimation may be performed for each macroblock using HVSBM or fixed-size block matching algorithm (BMA). In the BMA, pixels in a given motion block are compared with pixels of a search area in a reference frame and a displacement with a minimum error is determined as a motion vector. The motion estimator 290 sends motion data such as motion vectors obtained as a result of motion estimation, a motion block type, and a reference frame number to an entropy coding unit 233.

The motion compensator 280 performs motion compensation on a reference frame using the motion vectors and generates a motion-compensated frame. The motion-compensated frame is a virtual frame consisting of blocks in a reference frame corresponding to blocks in a current frame and is transmitted to a switching unit 295.

The switching unit 295 receives a motion-compensated frame received from the motion compensator 280 and a base layer frame provided by the base layer encoder 100 and sends textures of the frames to a subtractor 205 on a motion block basis. Of course, when a base layer has a different resolution than an enhancement layer, an upsampling process must be performed on the base layer frame generated by the base layer encoder 100 before it is transmitted to the switching unit 295.

The subtractor 205 subtracts the texture received from the switching unit 295 from a predetermined motion block (current motion block) in the input frame in order to remove redundancy within the current motion block. That is, the subtractor 205 calculates a difference between the current motion block and its corresponding motion block in a motion-compensated frame (hereinafter called a “first prediction residual”) and a difference between the current motion block and its corresponding region in a base layer frame (hereinafter called a “second prediction residual”).

The first and second prediction residuals are lossily encoded as they pass through a spatial transformer 231 and a quantizer 232 and then losslessly encoded by the entropy coding unit 233.

A mode selector 270 selects one of the first and second prediction residuals encoded by the entropy coding unit 233, which offers higher coding efficiency. For example, the method described with reference to the equation (3) may be used for this selection. Because the first and second prediction residuals are calculated for each motion block, the mode selector 270 iteratively performs the selection for all motion blocks.

The entropy coding unit 233 that receives the result (represented by an index 0 or 1) selected by the mode selector 270 through the comparison and selection outputs a bitstream corresponding to the selected result.

To support closed-loop encoding in order to reduce a drifting error caused due to a mismatch between an encoder and a decoder, the video encoder 3000 includes the inverse quantizer 252, the inverse spatial transformer 251, and an adder 251. The adder 215 adds a residual frame reconstructed by an inverse spatial transformer 251 to the motion-compensated frame output by the motion compensator 280 to reconstruct a reference frame that is then sent to the motion estimator 290.

Because a downsampler 110, an upsampler 120, and the base layer encoder 100 performs the same operations as their counterparts in the first exemplary embodiment shown in FIG. 8, their description will not be given.

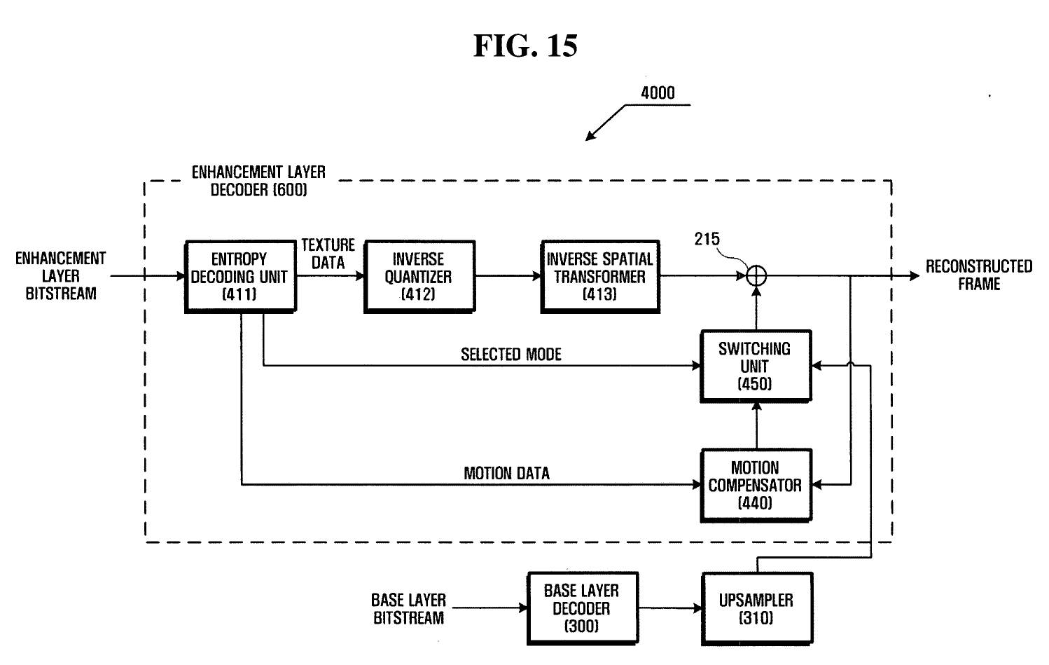

FIG. 15 is a block diagram of a video decoder 4000 according to a second embodiment of the present invention. Referring to FIG. 15, the video decoder 4000 mainly includes a base layer decoder 300 and an enhancement layer decoder 600.

An entropy decoding unit 411 performs lossless decoding that is an inverse operation of entropy encoding to extract a selected mode, motion data, and texture data for each motion block. The selected mode means an index (0 or 1) indicating the result selected out of a temporal residual (“third prediction residual”) and a residual between a current motion block and a corresponding region in a base layer frame (“fourth prediction residual”), which are calculated by the video encoder 3000 for each motion block.

The entropy decoding unit 411 provides the selected mode, the motion data, and the texture data to a switching unit 450, a motion compensator 440, and an inverse quantizer 412, respectively. The inverse quantizer 412 performs inverse quantization on the texture data received from the entropy decoding unit 411. The inverse quantization is an inverse operation of the quantization which has been performed by the quantizer (232 of FIG. 14) of the enhancement layer encoder (500 of FIG. 14).

An inverse spatial transformer 413 performs inverse spatial transform to reconstruct a residual image from coefficients obtained after the inverse quantization for each motion block.

The motion compensator 440 performs motion compensation on a previously reconstructed video frame using the motion data received from the entropy decoding unit 411 and generates a motion-compensated frame, of which an image corresponding to the current motion block (first image) is provided to the switching unit 450.

The base layer decoder 300 reconstructs a base layer frame from a base layer bitstream and sends an image of the base layer frame corresponding to the current motion block (second image) to the switching unit 450. Of course, when necessary, an upsampling process may be performed by an upsampler 310 before the second image is transmitted to the switching unit 450.

The switching unit 450 selects one of the first and second images according to the selected mode provided by the entropy decoding unit 411 and provides the selected image to an adder 215 as a predicted block.

The adder 215 adds the residual image reconstructed by the inverse spatial transformer 413 to the predicted block selected by the switching unit 450 to reconstruct an image for the current motion block. The above process is iteratively performed to reconstruct an image for each motion block, thereby reconstructing one frame.

The present invention allows multi-layered video coding that is well suited for characteristics of an input video. The present invention also improves the performance of a multi-layered video codec.

In FIGS. 8, 11, 14, and 15, various functional components mean, but are not limited to, software or hardware components, such as a Field Programmable Gate Arrays (FPGAs) or Application Specific Integrated Circuits (ASICs), which perform certain tasks. The components may advantageously be configured to reside on the addressable storage media and configured to execute on one or more processors. The functionality provided for in the components and modules may be combined into fewer components and modules or further separated into additional components and modules.

As described above, according to the present invention, methods for encoding video based on a multi-layered video coding can be performed in a more suitable manner to input video characteristics. In addition, the present invention provides for improved performance of a video codec.

In concluding the detailed description, those skilled in the art will appreciate that many variations and modifications can be made to the preferred embodiments without substantially departing from the principles of the present invention. Therefore, the disclosed exemplary embodiments of the invention are used in a generic and descriptive sense only and not for purposes of limitation.

What is claimed is:

1. A method for encoding video based on a multi-layer structure, comprising:
performing intra-prediction on a current intra-block using images of neighboring intra-blocks of the current intra-block to obtain a prediction residual;
performing prediction on the current intra-block using an image of a lower layer region corresponding to the current intra-block to obtain a prediction residual;
selecting one of the two prediction residuals that offers higher coding efficiency; and
encoding the selected prediction residual.

2. The method of claim 1, wherein the intra-prediction is performed according to 8 directional intra-prediction modes.

3. The method of claim 1, wherein the intra-block has a size of 4×4 pixels.

4. The method of claim 2, wherein the intra-prediction is performed using 9 intra-prediction modes that are the 8 directional intra-prediction modes plus a prediction mode used in the performing of the prediction using the lower layer image.

5. The method of claim 1, wherein the image of the lower layer region is an image of a region of a lower layer frame corresponding to the current intra-block, which is reconstructed through decoding.

6. The method of claim 1, wherein the image of the neighboring intra-block is an image reconstructed by decoding the neighboring intra-block.

7. The method of claim 1, wherein the coding efficiency is determined by a rate-distortion based cost function.

8. The method of claim 1, wherein the encoding of the selected prediction residual comprises:
performing spatial transform on the selected prediction residual to create transform coefficients;
quantizing the transform coefficients to generate quantization coefficients; and
losslessly encoding the quantization coefficients.

9. A method for decoding video based on a multi-layer structure, comprising:
extracting modified intra-prediction modes and texture data for each intra-block;
generating a residual image for the intra-block from the texture data;
generating a predicted image for a current intra-block using previously reconstructed neighboring intra-blocks or a previously reconstructed lower layer image according to the modified intra-prediction mode; and
adding the predicted image to the residual image and reconstructing an image of the current intra-block.

10. The method of claim 9, wherein the generating of the residual image from the texture data comprises inversely quantizing the texture data and performing inverse spatial transform on the inversely quantized result.

11. The method of claim 9, wherein the modified intra-prediction mode includes 8 directional intra-prediction modes and a prediction mode used for performing prediction from a corresponding lower layer region.

12. A method for encoding video based on a multi-layer structure, comprising:
performing temporal prediction on a current motion block using an image of a region of a reference frame corresponding to the current motion block to obtain a first prediction residual;
performing prediction on the current motion block using an image of a lower layer region corresponding to the current motion block to obtain a second prediction residual;
selecting one of the first and second prediction residuals that offers higher coding efficiency; and
encoding the selected prediction residual.

13. The method of claim 12, wherein the motion block is generated by hierarchical variable size block matching (HVSBM).

14. The method of claim 12, wherein the motion block is generated by fixed-size block matching.

15. The method of claim 12, wherein the coding efficiency is determined by a rate-distortion based cost function.

16. The method of claim 12, wherein the image of the lower layer region is an image of a region of a lower layer frame corresponding to the current intra-block, which is reconstructed through decoding.

17. The method of claim 12, wherein the reference frame is a frame obtained by encoding a frame at a different temporal position than the current motion block and decoding the encoded frame.

18. A method for decoding video based on a multi-layer structure, comprising:
extracting selected mode, motion data, and texture data for each motion block;
generating a residual image for the motion block from the texture data;
selecting one of an image of a region of a previously reconstructed reference frame corresponding to the motion block and a previously reconstructed lower layer image according to the selected mode; and
adding the selected image to the residual image and reconstructing an image of the motion block.

19. The method of claim 18, wherein the generating of the residual image from the texture data comprises inversely quantizing the texture data and performing inverse spatial transform on the inversely quantized result.

20. A video encoder comprising:
a unit configured to perform intra-prediction on a current intra-block using images of neighboring intra-blocks of the current intra-block to obtain a prediction residual;
a unit configured to perform prediction on the current intra-block using an image of a lower layer region corresponding to the current intra-block to obtain a prediction residual;
a unit configured to select one of the two prediction residuals that offers higher coding efficiency; and
a unit configured to encode the selected prediction residual.

21. A video decoder comprising:
a unit configured to extract modified intra-prediction modes and texture data for each intra-block;
a unit configured to generate a residual image for the intra-block from the texture data;
a unit configured to generate a predicted image for a current intra-block using previously reconstructed neighboring intra-blocks or a previously reconstructed lower layer image according to the modified intra-prediction mode; and
a unit configured to add the predicted image to the residual image and reconstruct an image of the current intra-block.

22. A video encoder comprising:
a unit configured to perform temporal prediction on a current motion block using an image of a region of a reference frame corresponding to the current motion block to obtain a first prediction residual;
a unit configured to perform prediction on the current motion block using an image of a lower layer region corresponding to the current motion block to obtain a second prediction residual;
a unit configured to select one of the first and second prediction residuals that offers higher coding efficiency; and
a unit configured to encode the selected prediction residual.

23. A video decoder comprising:
a unit configured to extract selected mode, motion data, and texture data for each motion block;
a unit configured to generate a residual image for the motion block from the texture data;
a unit configured to select one of an image of a region of a previously reconstructed reference frame corresponding to the motion block and a previously reconstructed lower layer image according to the selected mode; and
a unit configured to add the selected image to the residual image and reconstructing an image of the motion block.
